(19) United States
(12) Patent Application Publication
(10) Pub. No.: US 2011/0309695 A1
(43) Pub. Date: Dec. 22, 2011

(54) INTERNALLY COOLED SERVO MOTOR WITH DRY ROTOR

(76) Inventor: STEVEN R. HUARD, Rohnert Park, CA (US)

(21) Appl. No.: 13/164,218

(22) Filed: Jun. 20, 2011

Related U.S. Application Data
(60) Provisional application No. 61/356,792, filed on Jun. 21, 2010.

(51) Int. Cl. H02K 9/20; H02K 37/02; H02K 9/19

(52) U.S. Cl. 310/46; 310/54

(57) ABSTRACT

A cooling system for an electric motor is equipped with cooling tubes for transporting a cooling fluid, the tubes are installed within the slots along with the motor winding. The cooling tubes make direct contact with the windings of the motor through a thermal conductive coating that is also electrically insulating. In one embodiment of the invention the cooling tubes are made from a hollow copper tube that is coated with Kapton® (polyimide).

### CROSS-REFERENCE TO RELATED CASES

This application claims the benefit of U.S. Provisional Application Ser. No. 61/356,792; filed Jun. 21, 2010, the disclosure of which is expressly incorporated herein by reference.

### TECHNICAL FIELD

The present invention relates to active cooling of AC and DC electric motors, and more particularly, electric motors that allow the use of water based or electrically conductive coolants to cool the stator coils directly from inside the winding slots.

### BACKGROUND OF INVENTION

There are three main classes of prior art for cooling an electric motor. The first class of liquid cooling involves using a liquid tight housing, item 22 in FIG. 7, or, items 27 and 28 in FIG. 8 that is installed over the stator housing 21. The second class of liquid cooling involves flooding the inside of the motor housing 21 with oil, or a suitable dielectric cooling fluid 23 as indicated in FIG. 9. The third class of liquid cooling involves using a two-phase liquid/gas coolant as depicted in U.S. Pat. No. 5,952,748.

The first class of prior art involves a liquid coolant 28 that flows in liquid tight passages 22 or 27 and 28 or over the electric motor housing 21, referred to in FIG. 6. The liquid 26 will pick up heat from the housing 21 as the liquid flows through the fluid tight cavity. This means of cooling is known in the industry to be very simple and effective.

The disadvantage of this method of cooling is that heat in the form of resistive losses will need to conduct from the winding 15 to the stator lamination material 12, to the housing 21 and then to the liquid 28. This path is indicated by the arrows in the lower right corner of FIG. 7. Even though this path of heat flow is mainly conductive, and through metallic media, which has relatively high thermal conductivity, the temperature drop can be significant; the maximum liquid temperature is often as high as 100 degrees Celsius and the maximum winding temperature is often as low as 125 degrees Celsius. A few degrees of temperature drop can result in a large reduction in motor output power because every degree of temperature drop in the heat path equates to a reduction in the phase currents in order to keep the winding temperature below the maximum winding temperature.

To further complicate the heat flow situation, the eddy currents and hysteresis losses in the stator lamination material 12 can be significantly higher than the resistive losses at the high speeds that the motor may be required to run. This causes a temperature rise from the stator lamination stack 12 to the cooling fluid 28, which results in impeding the resistance in the windings 15 from escaping the motor. In other words, because of the resulting temperature rise caused by the eddy current and hysteresis losses, as the motor spins faster, the motor phase currents need to be reduced in order to prevent the motor from overheating. The reduction in current will reduce the motor output torque and power.

The second class of liquid cooling involves flooding the inside of the motor housing 21 with a dielectric cooling fluid 23, as indicated in FIG. 9. In this type of cooling, the entire inside of the motor is wet including the shaft 14 and magnet segments 17. The fluid is pumped through the fluid tight motor housing 21 in order to remove heat from all surfaces that the cooling fluid 23 is in contact with.

There are a few disadvantages with this type of cooling. First, the cooling fluid 23 needs to be a dielectric because the magnetic and electric fields induced in the liquid by the stator windings and the rotating shaft 14 and magnets 17 will cause current to flow if the fluid is conductive. This limits the type of cooling fluids that can be used and specifically eliminate the most commonly used coolant, 50/50 water glycol. Water glycol can be used; however it will require a separate heat exchanger in order to transfer heat from the dielectric to the water/glycol cooling loops. The second disadvantage of the flooded motor is that there will be significant fluid losses in the dielectric as it travels through the gap between the rotor magnets 17 and the stator laminations 12. These losses are approximately proportional to the rotor speed squared. Therefore, at high motor speeds the dielectric becomes a source of losses and therefore reduces the overall efficiency of the motor, and the work done on the fluid by the spinning rotor adds to the heat load of the cooling system. This is a similar cooling method that is described in U.S. Pat. No. 2,648,789. There are classes of internal cooling, using a dielectric, in which the fluid is sprayed or trickled in the motor cavity. This eliminates the heat caused by the fluid churning in motor air gap; however a separate cooling loop is still required.

The third class of cooling system involves using a two-phase cooling fluid such as FREON® or an automotive refrigerant such as R-134. The disadvantage of this type of system is in the expense and complexity of the two phase coolant system. A two-phase coolant system is presented in Boldlehner U.S. Pat. No. 5,952,748. The system in the Boldlehner patent is practical because the motor is compressing FREON®. Such a system would not be practical for a vehicle traction electric motor because of the expense.

### SUMMARY

At least one embodiment of the invention provides a permanent magnet brushless motor comprising: a stator, at least two slots in the stator, at least one windings inserted in the at least two slots, at least one cooling tube that is installed in the said slots in proximity with the windings; an electrically isolative material positioned between the cooling tube and the winding, a rotor that is installed within the stator, at least two magnet poles on said rotor, and, with the said permanent magnet poles presented circumferentially on the said rotor.

At least one embodiment of the invention provides an induction motor comprising: a stator, at least two slots in the stator, at least one windings inserted in the slots, at least one cooling tube that is installed in the slots in proximity with the windings, an electrically isolative material installed between said cooling tube and said winding, a rotor that is installed within the said stator, a stack of lamination installed on the rotor, at least two slots on the rotor, and at least two conductive bars on the rotor presented circumferentially on the rotor inside the slots.

At least one embodiment of the invention provides a brushed motor comprising: a stator, at least two slots in the stator, at least one stator winding inserted in the slots, at least one cooling tube that is installed in the slots in proximity with the windings, an electrically isolative material installed between the cooling tube and the winding, a rotor that is installed within the stator, at least one rotor winding on the rotor, a stack of lamination installed on the rotor, wherein the rotor winding is installed on the rotor inside the lamination slots.

At least one embodiment of the invention provides a switch reluctance motor with in slot cooling comprising: a stator, at least two slots in the stator, at least one stator winding inserted in the slots, at least one cooling tube that is installed in the slots in proximity with the windings, an electrically isolative material installed between the cooling tube and the winding, and a rotor that is installed within the stator, the rotor comprising a magnetic steel and having an alternating pattern of teeth and valley around a circumference of the rotor.

### BRIEF DESCRIPTION OF THE DRAWINGS

Embodiments of this invention will now be described in further detail with reference to the accompanying drawings, in which:

FIG. 1 is a perspective view of an electric motor in accordance with an embodiment of the invention shown with two stator teeth removed and one stator tooth partially exploded to show the path of the coolant flow tube;

FIG. 2 is a perspective view of an electric motor of FIG. 1 shown with the stators in place;

FIG. 3 is a perspective view of the coolant flow tube of FIG. 1;

FIG. 4 is a cross-sectional view of the motor of FIG. 1;

FIG. 5 is a un-rolled view of the cooling tube shown serpentine through the slots between the stator teeth;

FIG. 6 is a longitudinal cross-sectional view of a prior art cooling system utilizing a cooling plate on the outside of the motor housing;

FIG. 7 is a radial cross-sectional view of the prior art motor of FIG. 6;

FIG. 8A is an un-rolled side view of a prior art cooling jacket;

FIG. 8B is a cross-sectional view of the prior art cooling jacket of FIG. 8A; and

FIG. 9 is a longitudinal cross-sectional view of a prior art motor utilizing interior dielectric cooling system.

### DETAILED DESCRIPTION OF THE DRAWING

The intent of this invention is to produce an electric motor that is liquid cooled in a manner so as to maximize the output power and torque, while reducing the cost and complexity of the coolant system, and utilize common coolant types such as 50/50 water glycol.

An electric motor generates heat in the process of transforming electrical energy into mechanical energy. If this heat is not effectively dissipated to the surrounding environment the motor internal temperature will rise above the temperature rating of the individual components. Without an active cooling system such as a fan or liquid cooling system, the servo motor continuous output power can be extremely reduced from its full potential.

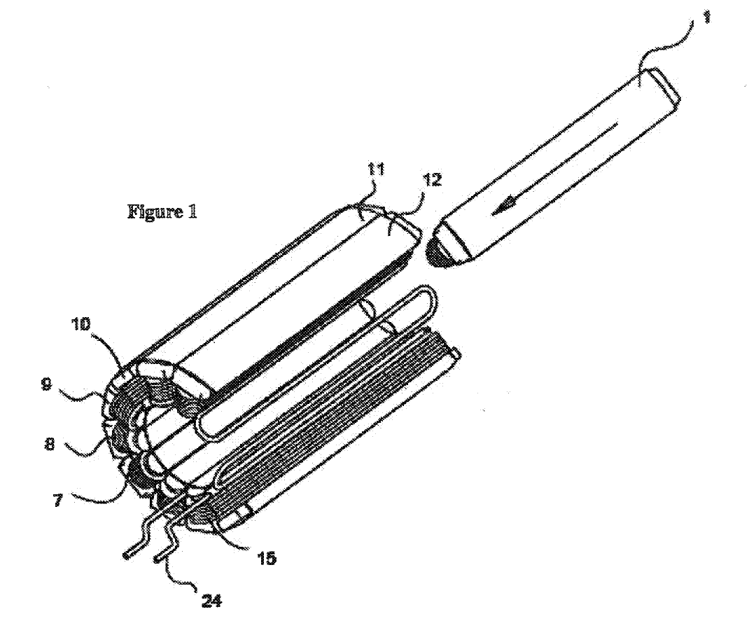

In accordance with this invention, cooling tubes 24 that contain the liquid coolant 19 are placed in the slots in the electric motor stator 1-12 along with the phase windings 15; refer to FIGS. 1-4. The cooling tubes 24 that are placed in the slots in proximity to the phase windings 15 have a much more effective heat flow path as compared to the traditional path thought the stator laminations 1-12 to the housing 21. Normally, tubes placed in the slots of an electric motor are subject to electromotive force, EMF, that is induced by the stator winding 15 and the rotating rotor magnets 17. This EMF induces current in the tubes and the coolant if either or both are electrically conductive. These inducted currents can be significant in magnitude so as to have a negative adverse effect on the electric motor performance. In fact, the conduction paths through the tube and fluid can cause the motor to be completely non-operable.

In accordance with this invention the coolant tubes are placed in a manner by which the induced EMF currents are reduced to an insignificant level. The following derivation will show which cooling flow paths result in zero EMF generated in the coolant or coolant tubes. Consider an electric motor with the parameters indicated in Table 1. An equation can be written that indicates the voltage in a conducting loop around a stator tooth Jₜ; refer to Equation 1.

$${V}_{Jt} = {K}_{bpt} sin [ \frac{{N}_{p}}{2} ( ω - 2 π \frac{{J}_{t}}{{N}_{t}} ) + \frac{2 π}{3} ] \qquad Equation 1$$

This equation is valid for any combination of stator slots and rotor poles. In order for the cooling tubes to be installed in the slots along with the motor winding the net EMF voltage must be zero or near zero for all time. This means that cooling tube will need to travel through the stator in such a path as to ensure that the net EMF voltage cancels among the individual teeth that the tube travels around.

TABLE 1
Motor Parameter Definitions

| Sym | Description |
|---|---|
| Nₜ | The total number of stator teeth on the stator lamination. |
| | This is also equal to the total number of slots on the |
| | stator. |
| Nₚ | The total number of north poles plus south poles on |
| | the rotor. |
| K_{bpt} | The voltage constant per tum of wire in a slot in volts |
| | rms per rpm. |
| Jₜ | A number that indicates the position of the stator |
| | lamination tooth with respect to the 12:00 position. The |
| | number increases as we move clockwise. At the 12:00 |
| | position Jₜ = 1. 1 ≦ Jₜ ≦ Nₜ |
| ω | The mechanical angular velocity of the rotor in rad/s. |
| Vⱼₜ | This is the induced EMF voltage as a function of time |
| | for a loop of conductive cooling tube that is completely |
| | around tooth number Jₜ wrapped in the clockwise |
| | direction. If a negative sign is present in the subscript |
| | then it is wrapped in the counter clockwise direction. |
| V_{{a,b,c, . . . k}} | This is the voltage as a function of time for a loop of |
| | conductive cooling tubes that is completely around |
| | multiple teeth Jₜ = a, Jₜ = b, Jₜ = c . . . and Jₜ = k. |
| | If a subscript has a minus sign in front of it then the tube |
| | is wound in the counter clockwise direction. |

Equation 2 indicates the mathematical rule that must be adhered to. In general, This equation must hold regardless of the number of stator teeth or rotor poles. If Equation 2 does not result in zero significant current will flow through the cooling tube and it will cause the motor to be non-operative.

Equation 2 states that the sum of the induced voltages in the individual loops must be zero. This equation must hold regardless of the number of stator teeth or rotor poles. If Equation 2 does not result in zero significant current will flow through the cooling tube and it will cause the motor to be non-operative.

V_{{a,b,c, . . . k}}=0=Vₐ+V_{b}+V_{c}+ . . . +Vₖ Equation 2:

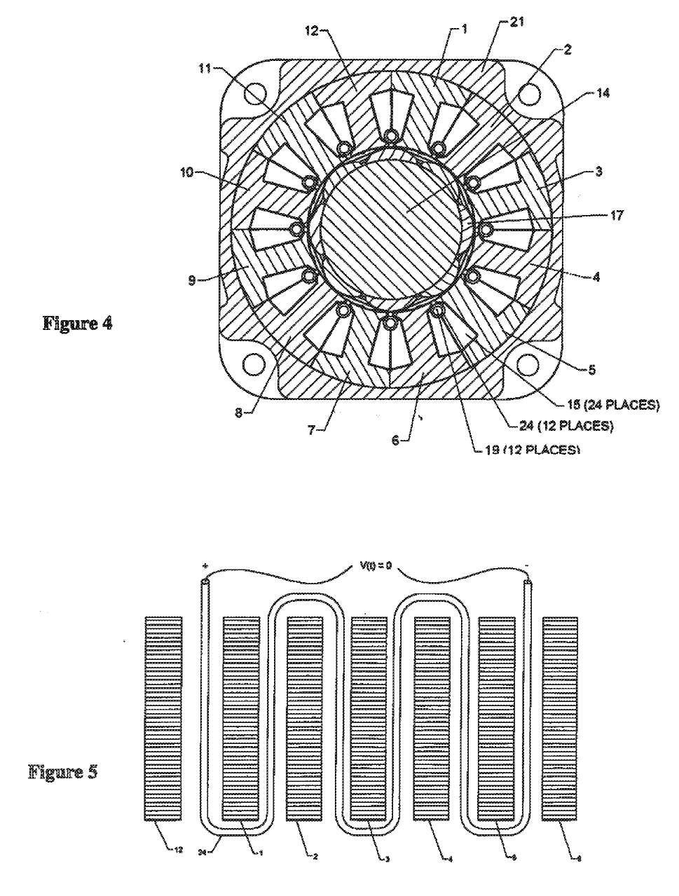

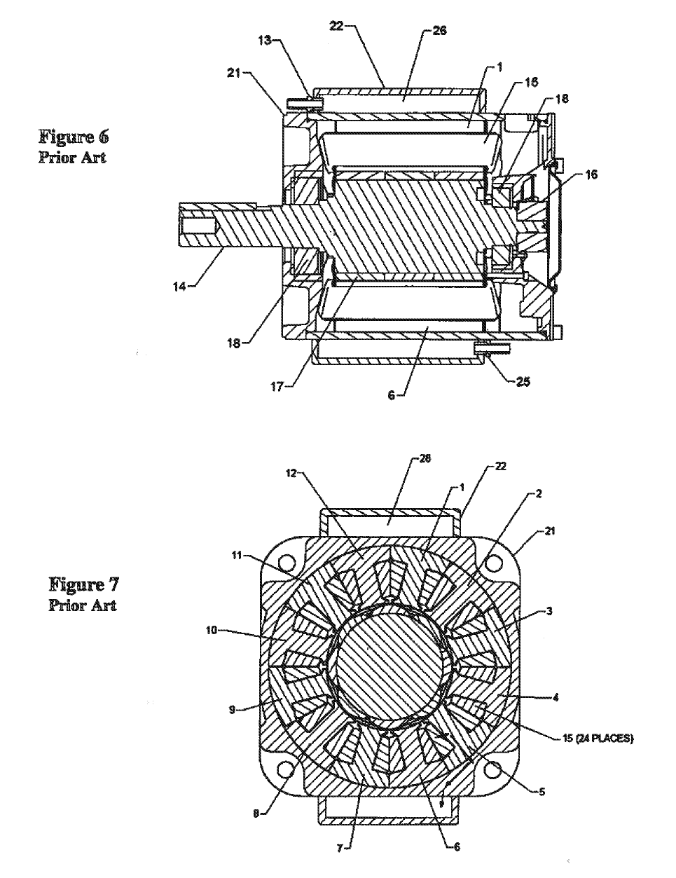

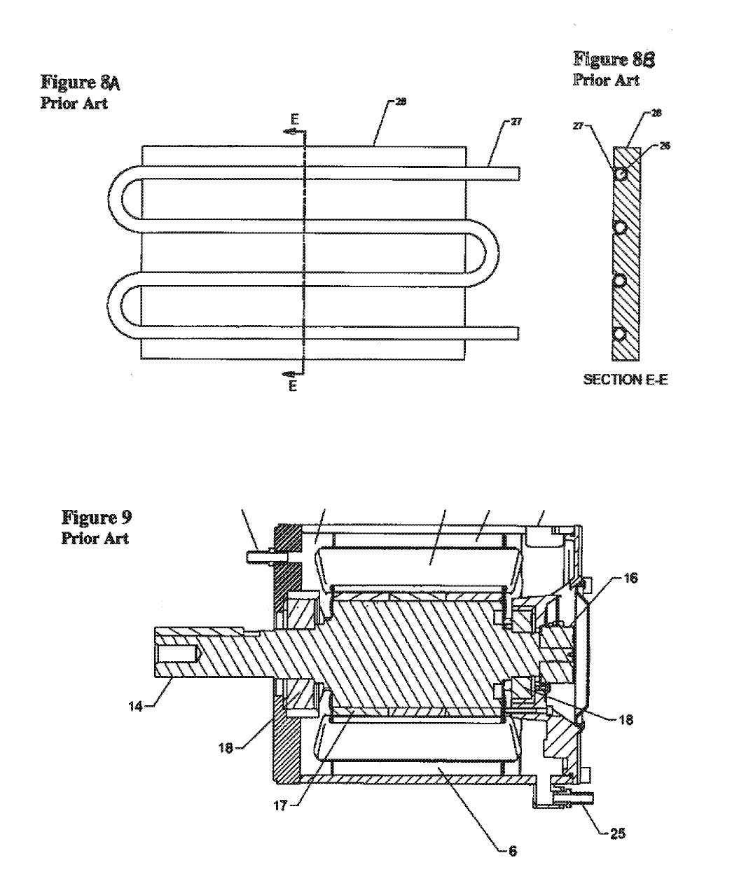

Let us consider the case where an electric motor is built with the number of stator teeth, Nₜ=12, and the number rotor magnets, Nₚ=8 as indicated in FIG. 4. In this electric motor let us choose a coolant loop path that goes around teeth number 1, 3 and 5, in the clockwise direction, therefore,

Jₜ={1,3,5}.

If one combines This equation must hold regardless of the number of stator teeth or rotor poles. If Equation 2 does not result in zero significant current will flow through the cooling tube and it will cause the motor to be non-operative.

Equation 2 along with Jₜ={1,3,5}, and the given motor parameters in Table 1, then Equation 3 will result. Further reducing Equation 3 will result in

Equation 4, then Equation 5.

$$\begin{matrix}{V}_{\{ 1 , 3 , 5 \}} = {K}_{bpt} \{ sin [ 4 ( ω - 2 π \frac{1}{12} ) + \frac{2 π}{3} ] + sin [ 4 ( ω - 2 π \frac{3}{12} ) + \frac{2 π}{3} ] + sin [ 4 ( ω - 2 π \frac{5}{12} ) + \frac{2 π}{3} ] \} & Equation 3 \\ {V}_{\{ 1 , 3 , 5 \}} = {K}_{bpt} \{ sin ( 4 ω ) + sin ( 4 ω - \frac{2 π}{3} ) + sin ( 4 ω + \frac{2 π}{3} ) \} & Equation 4\end{matrix}$$

And therefore,

V_{{1,3,5}}=0 Equation 5:

The coolant path defined by Equation 5 is indicated in FIG. 5. It can be shown for the set of motor parameters that are indicated in Table 1 that the following equations also hold true:

V_{{2,4,6}}=0

V_{{1,3,5,7,9,11}}=0

V_{{2,4,6,8,10,12}}=0

V_{{1,-7}}=V_{{3,-9}}=V_{{5,-11}}=0

It can also be shown that the higher harmonic content of the back EMF is also zero for the above examples. Other combinations that result in zero EMF are also possible, such as a coolant tube that travels in and out of the same slot. If the number of stator teeth and the number of rotor magnets are different than indicated in Table 1 then the path that the cooling loop must take in order for the voltage to cancel will also change.

A servo motor in accordance to this invention can be constructed as indicated in FIGS. 1-4, with twelve stator teeth 1-12, eight magnet segments 17, and one continuous flow cooling tube 24, however, the invention is not limited to a particular number of stator teeth, magnet segments, or a particular cooling tube travel path. The servo motor depicted in FIGS. 1-4 is a permanent magnet synchronous servo motor. It is constructed with a rotor 14 that has permanent magnet segments 17, attached circumferentially. The rotor 14 rotates on bearings 18. The stator 1-12 is constructed from electrical grade steel in the form of a stack of laminations in order to reduce eddy current and hysteresis losses. Coils of wire, or windings, 15, are installed into the slots between the laminations stacks 1-12. A feedback device 16 is used to sense the rotor 14 position during motor operation.

During the operation of the servo motor, current is commanded through the motor winding 15 that is a function of rotor position, and the commanded torque. Resistive losses in the motor windings 15 and eddy currents and hysteresis losses in the lamination stack 1-12 cause the motor to heat. The heat generated must be effectively removed from the motor or the motor will over heat.

The electric motor is equipped with cooling tubes 24 that are installed within the slots along with the motor winding. The cooling tubes make direct contact with the winding through a thermal conductive coating however, the coating must also be electrically insulating. In one preferred embodiment of the invention, the cooling tubes are made from a hollow copper tube that is coated with Kapton® (polyimide). The polyimide insulation is ideal for this invention because it has excellent electrical insulation properties and relatively good thermal conductivity compared to other electrically insulating material. As an alternative, the cooling tube could be made from aluminum, and the coating could be made from ceramic.

The path of the internal cooling tube must be selected so the inducted EMF from the rotating rotor magnets is essential zero for all time. If the EMF does not net to zero for all time, current will be induced in the cooling tube and/or the coolant and the result will be an adverse effect on the motor performance.

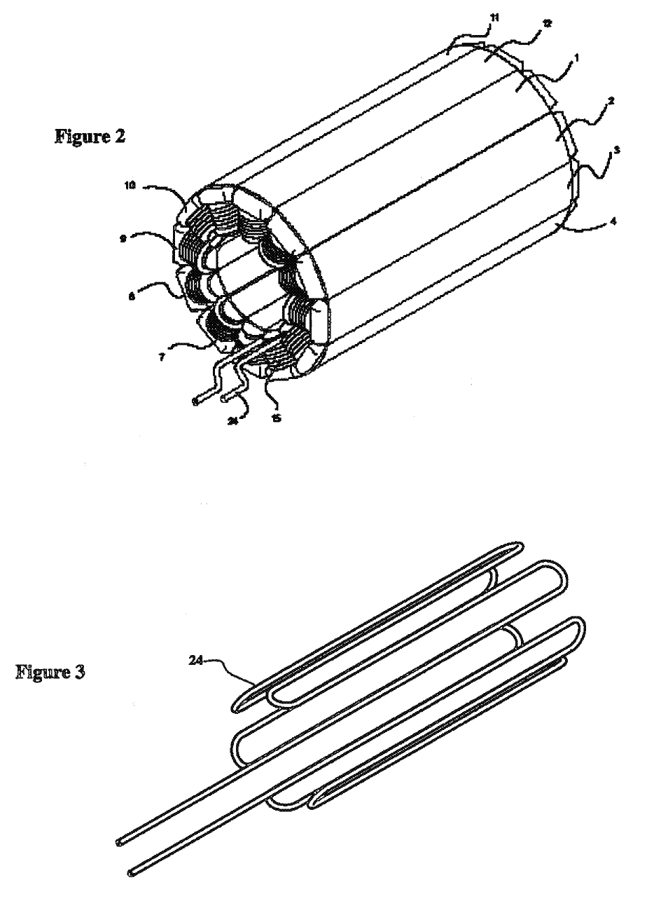

In order to reduce the complexity of the assembly it is preferred that the tube has a minimum number of interconnection within the motor body. Therefore, a single pass continuous tube is preferred. It is possible to assemble the motor with a single continuous tube if the motor stator is built in segments. In an embodiment of this invention where a single continuous tube is used, the stator is constructed around the cooling tube by sliding stator teeth 1, 3, 5, 7, 9, and 11 into the bends of the tube from the top of the cooling tube. Stator teeth 2, 4, 6, 8, 10, and 12 are inserted into the bends of the cooling tube up from the bottom as shown in FIG. 1 and FIG. 2.

It is possible to maximize the thermal path from the winding to the cooling tube by maximizing the thermal contact between the cooling tube and the wires and then encapsulate the entire stator in a thermally conductive epoxy. The encapsulation process also protects the insulation from abrasion failures. The insulation on the copper tube needs to be thick enough to protect it from shorts to the motor phase wires and shorts to the motor laminated teeth. If the cooling tube shorts to the lamination stack in more than one place it is possible that some parasitic current can flow in the motor lamination stack due to induced EMF in the copper tubes between the contact point.

The cooling fluid in one embodiment is a 50/50 water-glycol. Water-glycol is suited for this invention because it has a low viscosity and a high thermal capacity. Also since this invention is targeted to the electric vehicle market the water-glycol is already widely used in the auto industry. It is an ideal coolant because it has a low viscosity, high thermal capacity and both high and low temperature compatible.

The insulation on the cooling tube can be made from a variety of different substances. For example, powder coat, ceramic, Nomex®, Mylar®, and Nylon to name a few. Each insulation type will have different trade-offs between cost and effectiveness. Also, different pole and slot combination other than the 8 magnet poles and 12 slot stator design shown herein can work. Virtually every common pole and slot counts used to make servo motors will have cooling tube routes that will produce a net zero voltage in the cooling tube; however, the electric motors with low pole and slot counts, that are built with segmented stators are the easiest to construct using this invention.

There are also a variety of tube materials that will work. For example, copper, aluminum, brass, stainless steel, plastic or polyimide only (without a copper inside) tubes will also work.

The internal cooling loop can be used along with external cooling method to make even further improvement to the servo motor performance. The internal cooling loop will remove the heat from the resistive losses while the external cooling on the housing can remove the eddy current and hysteresis losses in the electrical steel.

This invention is not limited to permanent magnet synchronous servo motors. It can also work on induction motors, PM brushed motors, Universal motors, and variable reluctance motors.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

What is claimed is:

1. A permanent magnet brushless motor comprising:
a stator, at least two slots in the stator,
at least one windings inserted in the at least two slots,
at least one cooling tube that is installed in the said slots in proximity with the windings;
an electrically isolative material positioned between the cooling tube and the winding,
a rotor that is installed within the stator, at least two magnet poles on said rotor, and, with the said permanent magnet poles presented circumferentially on the said rotor.

2. The motor according to claim 1, wherein the electrically isolative material positioned between the cooling tube and the winding is a polyamide applied to the outside of the cooling tube.

3. The motor according to claim 1, wherein the electrically isolative material positioned between the cooling tube and the winding is a powder coat applied to the outside of the cooling tube.

4. The motor according to claim 1, wherein the electrically isolative material positioned between the cooling tube and the winding is a ceramic applied to the outside of the cooling tube.

5. The motor according to claim 1, wherein the motor is used in a vehicle.

6. The motor according to claim 1, wherein the cooling tube is made from copper.

7. The motor according to claim 1, wherein the cooling tube is made from aluminum.

8. The motor according to claim 1, wherein the cooling tube is made from stainless steel.

9. The motor according to claim 1, wherein the cooling tube is made from polyimide.

10. The motor according to claim 1, wherein the cooling fluid comprises a mixture of water glycol.

11. The motor according to claim 1, wherein the cooling fluid comprises R134.

12. The motor according to claim 1, wherein the cooling fluid comprises oil.

13. The motor according to claim 1, wherein the cooling fluid comprises a two-phase liquid gas mixture as the cooling fluid.

14. The motor according to claim 1 further comprising an encapsulant that fills an air void in the stator.

15. The motor according to claim 1, wherein the encapsulant is epoxy.

16. The motor according to claim 1, wherein encapsulant is varnish.

17. An induction motor comprising:
a stator,
at least two slots in the stator,
at least one windings inserted in the slots,
at least one cooling tube that is installed in the slots in proximity with the windings,
an electrically isolative material installed between said cooling tube and said winding,
a rotor that is installed within the said stator, a stack of lamination installed on the rotor, at least two slots on the rotor, and at least two conductive bars on the rotor presented circumferentially on the rotor inside the slots.

18. A brushed motor comprising:
a stator,
at least two slots in the stator,
at least one stator winding inserted in the slots,
at least one cooling tube that is installed in the slots in proximity with the windings,
an electrically isolative material installed between the cooling tube and the winding,
a rotor that is installed within the stator,
at least one rotor winding on the rotor, a stack of lamination installed on the rotor, wherein the rotor winding is installed on the rotor inside the lamination slots.

19. A switch reluctance motor with in slot cooling comprising:
a stator,
at least two slots in the stator, at least one stator winding inserted in the slots,
at least one cooling tube that is installed in the slots in proximity with the windings,
an electrically isolative material installed between the cooling tube and the winding, and
a rotor that is installed within the stator, the rotor comprising a magnetic steel and having an alternating pattern of teeth and valley around a circumference of the rotor.
